(19) United States
(12) Patent Application Publication
(10) Pub. No.: US 2005/0097154 A1
(43) Pub. Date: May 5, 2005

(54) Noise reduction in systems with an RF tuner front end

(76) Inventor: Michael J. Tsecouras, Carrollton, TX (US)

Correspondence Address: TEXAS INSTRUMENTS INCORPORATED, P O BOX 655474, M/S 3999, DALLAS, TX, 75265, US

(21) Appl. No.: 10/697,202

(22) Filed: Oct. 30, 2003

(51) Int. Cl. G06F 17/10

(52) U.S. Cl. 708/300

(57) ABSTRACT

A switching amplifier system to reduce noise outside of the information signal, but still within the Audio Signal Bandwidth. The present invention is advantageous for reducing noise in low cost systems which contain sensitive RF front ends that include a switching amplifier and or a Switched Mode Power Supply (SMPS). These power-switching systems can produce high frequency interfering signals, which reduce the audio performance of sensitive RF front-ends including AM/FM/TV band tuner areas. In contrast to metal shielding and EMI filters use in prior art solutions, the present invention can be implemented at low cost in existing digital silicon processes. In the present invention, a filter is provided that minimizes the in-band audio noise by carefully filtering the audio signal based a predicted interference pattern. The predicted interference pattern is determined by examining the key contributors to the EMI spectrum generation, and their mapping into the tuner frequency selected. A filter function is then chosen that will remove much of the audio in-band noise, without degrading the information signal.

### TECHNICAL FIELD OF THE INVENTION

This invention relates to noise reduction in electrical circuit amplifiers, and more particularly to noise reduction in amplifier systems with an RF tuner front end, particularly to those with noise from switching amplifiers and switched mode power supplies.

### BACKGROUND OF THE INVENTION

Switching amplifiers create electromagnetic interference (EMI) or noise that can create problems for other parts of the circuit or system. Many methods are use to reduce EMI contamination. These methods include the following:
A) Extensive metal shielding providing a ‘Faraday cage’ around the emitting source or around the receiving source—ie. Tuner Module.
B) High Order L-C lowpass filters—2^{nd} order to 6^{th} order, with 4^{th} order being most commonly used, often shielded inductor cores are used.
C) Power supply—High frequency (EMI) filters using ferrite beads, T-filters, etc. on power and ground as needed.
D) EMI filtered connectors to pass all power and signals into and out of the metal Faraday cage.

These and similar methods are useful to reduce the amplitude of the EMI generated by the switching amplifier. However, these methods add cost, and are time consuming to design and optimize. Various manufacturing tolerances must be considered to insure a robust design for high volume manufacturing but these add more weight, cost, and design time to the products. Another common solution for EMI reduction is spread spectrum switching controller design. This reduces energy in many frequency bands, but may still contain sufficient energy in certain critical energy bands which still require use of additional brute force EMI containment methods as described above.

### SUMMARY OF THE INVENTION

The present invention overcomes problems associated with the described prior art to reduce the interference energy in the audio band. In the present invention a systematic solution to reduce noise is illustrated. The problematic noise is often outside of the information signal, but still within the Audio Signal Bandwidth. The present invention is advantageous for reducing noise in low cost systems which contain sensitive RF front ends that include a switching amplifier and or a Switched Mode Power Supply (SMPS). These power-switching systems can produce high frequency interfering signals, which reduce the audio performance of sensitive RF front-ends including AM/FM/TV band tuner areas. In prior art solutions, the system integration was possible with expensive and bulky metal shielding around the power switching, along with liberal application of EMI filters on signals, power, and ground. The present invention can be implemented at low cost in existing digital silicon processes.

In the present invention, a filter is provided that minimizes the in-band audio noise by carefully filtering the audio signal based a predicted interference pattern. The predicted interference pattern is determined by examining the key contributors to the EMI spectrum generation, and their mapping into the tuner frequency selected. A filter function is then chosen that will remove much of the audio in-band noise, without degrading the information signal.

An added benefit of this filtering technique, is that it will reduce the mid to high frequency white noise (hiss), that occurs in tuners in all cases—even without the interference, so the SNR will be improved. Thus, this technique could be used to improve the SNR of a Tuner, in systems which don't include the switching amplifier, SMPS or other interfering noise sources.

### BRIEF DESCRIPTION OF THE DRAWINGS

FIG. 1 illustrates a block diagram of a system according to an embodiment of the present invention.

FIG. 2 illustrates a block circuit diagram of a noise reduction system for a system with an RF front end according to another embodiment of the present invention.

FIG. 3 illustrates a block circuit diagram of a noise reduction system for a system with an RF front end according to another embodiment of the present invention.

FIG. 4 illustrates a block circuit diagram of a noise reduction system for a system with an RF front end according to another embodiment of the present invention.

### DETAILED DESCRIPTION OF THE INVENTION

The present invention solves the noise interference problem in RF front end systems by application of a digital filter, which can be configured, based on the AM/FM/TV station selected. The system controller is responsible for programming the digital filter—based on a look-up table or an algorithm.

The availability of the frequency precision of this digital filter to accurately filter the tuner's output signal becomes quite useful in systems which have multiple interfering sources, such as a DSP and a micro-controller near the tuner module. Characterization of the system gives the spectral (FFT) information to design the Filter. Once all of the filters are designed, they are individually selected based on the AM/FM/TV tuner frequency chosen by the user. The filter selected will remove the in-band noise energy for the selected RF Tuner frequency.

It is expected, that for FM Tuner or TV Tuner selection the Programmable Filter cutoff frequency chosen might be around 15 kHz, where the sample rate chosen is often 48 kHz. However, due to the Frequency Precision of Digital Filtering using large digital filter coefficients, a more aggressive filtering scheme might be chosen for certain Tuner Frequencies selected. For example, there may be a (low to mid band) noise occurring in the audio band, and so a High Q notch or notches could be applied.

Since the Tuner is used to carry speech, or music program signals —the removal of a particular very narrow frequency (noise and signal) by the notch can often go un-noticed by a user. Broader filtering of the information signal is quite noticeable by the user, and often sounds much like a tone control (bass or treble) has been applied.

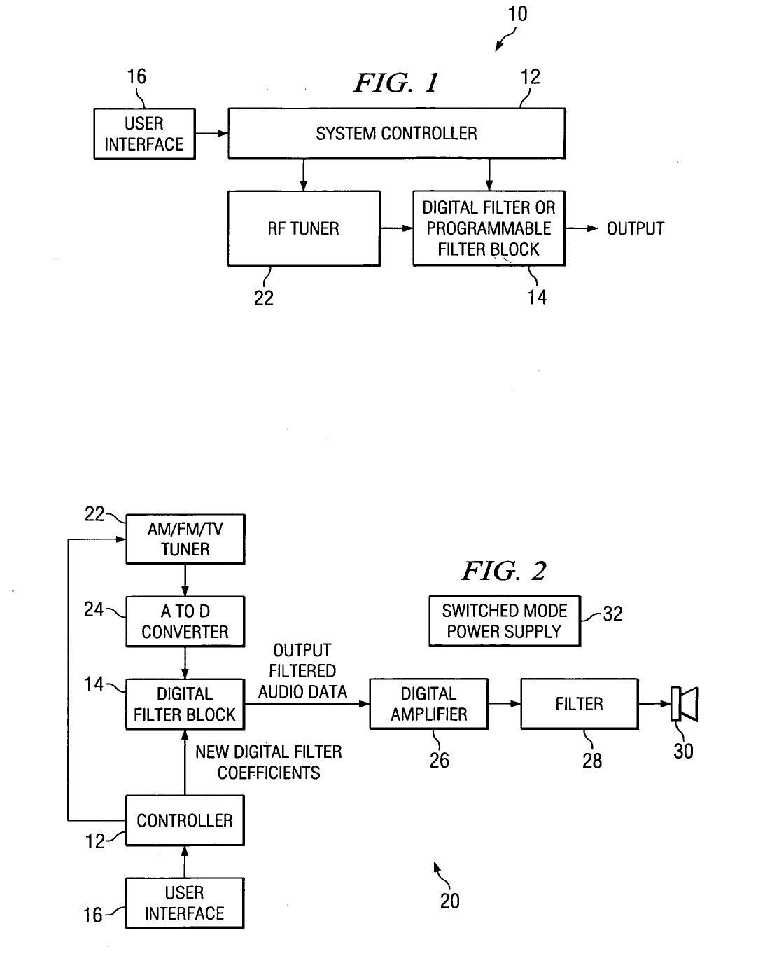

FIG. 1 illustrates a block diagram of a system according to an embodiment of the present invention. This embodiment illustrates an RF tuner system 10 with a system controller 12 and a digital programmable filter 14 to reduce audio in-band noise (improve SNR). An RF tuner circuit receives channel selection from the user interface, and outputs an RF signal to the programmable filter 14. The system controller 12 receives the AM/FM/TV frequency information from the user interface 16. The system controller 12 then programs the filter 14 for the proper characteristics based on the AM/FM/TV band and station selected by the user on the user interface 16. The system controller may use a look-up table or algorithm to output either digital filter coefficients, or control bits to select the filter function of the programmable filter block 14, whereby the system is able to optimize system performance, including SNR, for the station selected. The system is preferably characterized with the tuner and RF interfering noises included to generate the coefficients for the table or algorithm.

A digital Filter or analog Switch Capacitor filter structure can be used for the programmable filter block 14, as they have precise filtering characteristics that can be programmed. The digital filter will be programmed by selecting the appropriate filter coefficients for the desired filter. The accuracy of the filter is determined by the length of the coefficient for the sample rate used by the system. The Analog Switch Capacitor filter can be programmed either by the frequency of the clock provided, or by programming the inclusion or exclusion of certain switch and capacitor paths. By using certain switches and capacitor values for one selection will provide a certain filter function—for example a low pass filter, high pass filter, or notch. By selecting other paths using new combinations of switches and capacitors, another filter function can be chosen.

In another embodiment of the present invention also based on FIG. 1, a programmable cutoff frequency digital filter eliminates the in-band noise in the system. The filter block 14 is a simple Low Pass Filter with a programmable cutoff frequency. For example—in the AM case, a filter with a 3 kHz cutoff could be used. Since the Switching Amplifier usually operates at Sample Rates of 32 kHz and up, the Digital Filter can remove energy from the cutoff frequency selected, up to half of the sample rate used by the switching amplifier—which in this case covers much of the audio band (3 kHz to 16 kHz). For FM and TV a 15 kHz cutoff could be used. A 2^{nd} order or higher filter is preferable. A 4^{th} to 6^{th} order provides a noticeable improvement in the FFT and SNR. In this case, the system controller will only need to know the RF BAND selected, and send that information to the filter to set it up. For example, a 3-kHz cutoff will be used for AM only, but a 15 kHz cutoff will be selected for FM and TV bands.

FIG. 2 illustrates a block diagram of a system having a digital filter 14 combined with a digital switching amplifier 14 according to another embodiment of the present invention. In this embodiment as in the above embodiment, the system controller 12 receives the AM/FM/TV frequency information from the user interface 16. The system controller 12 then programs the digital filter 14 for the proper characteristics based on the AM/FM/TV band and station selected by the user on the user interface 16. The system controller may use a look-up table or algorithm to output either digital filter coefficients, or control bits to select the filter function of the programmable filter block 14. The tuner 22 provides an analog audio signal to an A/D converter 24. The A/D converter 24 outputs a corresponding digital signal to the digital filter 14. The filtered signal is then output from the digital filter 14 to the digital amplifier 26. An additional filter 28 can also filter the output of the amplifier prior to driving the speakers 30.

The switched mode power supply 32 is a primary contributor to the overall noise in the system. Other noise sources may also be present including a digital audio processor in the digital filter block 14. However, the present invention is also advantageous with linear power supplies but with a lower SNR improvement.

In preferred embodiments, a measurement of the system performance (SNR, THD+N, and Spectral information of the audio signal and the in-band noise.) is made for each RF station to determine the filter characteristics to be used as described in the previous paragraph.

Since the Tuner information is usually Analog, the Low Pass Filter function can be combined with the Digital Decimation Filter for an oversampling ADC. Normally the ADC filter Low pass frequency is set to the desired Sampling Rate divided by 2 (Fs/2) in order to remove aliasing components. However, in this case the oversampling rate and the output sample rate of the ADC remain unchanged, but the Low Pass filter can be set to either 3 Khz, 15 kHz, or the appropriate Bandwidth needed to pass the signal. The reason that the Sampling rate would be kept at the higher rate, is to keep the out of band noise energy very low (especially in the 3 kHz BW case where the out of band energy is well within the audio band). This technique is most useful when the signal is later reconstructed in a DAC or Digital Amplifier. (It would also be possible to set the ADC to a low sample rate, and then use a digital sample rate converter to bring the ADC sample rate back to the desired reconstruction Sampling rate—again, thereby minimizing the out of band noise energy.)

Based on individual station spectral data—a set of filters can be designed to minimize the energy of the noise component while minimizing audible effect to the audio signal. In the simpler embodiment, for each RF BAND there will be two filters—incorporating lowpass and notch filters—to minimize the energy of the noise. In a more complicated embodiment, one filter structure for each station could be used. Fixed frequency interferences usually show only a few “noise spectral fingerprints”, as these beat frequency patterns tend to repeat for a given RF BAND. So, as the RF Frequency is swept from the lowest frequency of the band to the highest frequency of the band (all tuner stations along the band), these spectral noise fingerprints can be recorded and compared. Therefore, a very good solution could be built, which has only a few filters, i.e. these few filters will be individually mapped to the station, that is selected by the user, for that BAND.

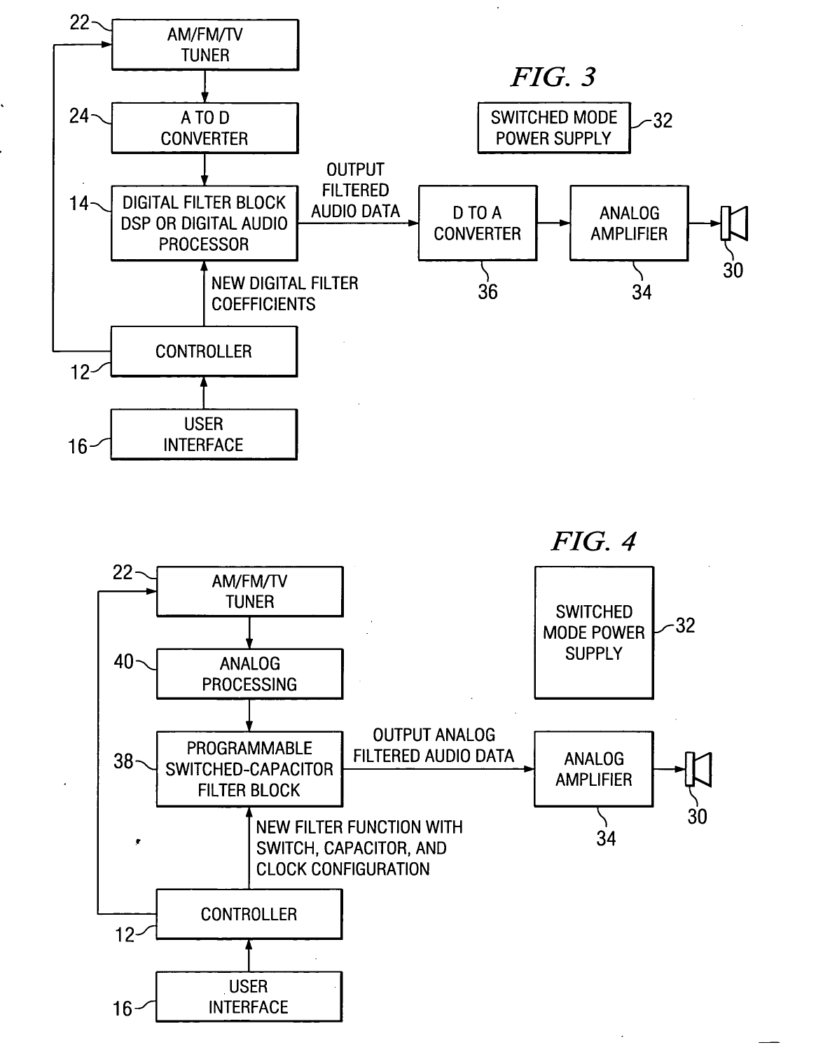

FIG. 3 illustrates a block diagram of a system having a digital filter 14 combined with an analog amplifier 34 according to another embodiment of the present invention. In this embodiment as in the above embodiment, the system controller 12 receives the AM/FM/TV frequency information from the user interface 16. The system controller 12 then programs the digital filter 14 for the proper characteristics based on the AM/FM/TV band and station selected by the user on the user interface 16. The system controller may use a look-up table or algorithm to output either digital filter coefficients, or control bits to select the filter function of the programmable filter block 14.

In FIG. 3, the tuner 22 provides an analog audio signal to an A/D converter 24. The A/D converter 24 outputs a corresponding digital signal to a D/A converter 36. The D/A converter outputs an analog signal to the amplifier 34. The amplifier 34 is preferably an analog class A/B amplifier, or an analog input class D amplifier. (When the class D amplifier is used, the amplifier is a noise source to the circuit in addition to the power supply, such as a switched mode power supply.) The output of the analog amplifier 34 drives the speakers 30.

FIG. 4 illustrates a block diagram of a system having a programmable switched capacitor block 38 combined with an analog amplifier 34 according to another embodiment of the present invention. In this embodiment as in the above embodiment, the system controller 12 receives the AM/FM/TV frequency information from the user interface 16. The system controller 12 then programs the switched capacitor block 38 based on the AM/FM/TV band and station selected by the user on the user interface 16. The tuner 22 provides an analog processing block that could provide optional processing such as special effects, mixer and volume control. The analog processing block 40 outputs an analog audio signal to the switched capacitor block 38. The switched capacitor block 38 outputs an analog signal to the analog amplifier 34. The output of the analog amplifier 34 drives the speakers 30.

Adaptive Filtering Embodiments

Digital Audio Processors or DSP's can provide real-time characterization for the determining interference frequencies and magnitudes. Adaptive filtering such as Kalman or other adaptive filtering types could be use to update the digital filter transfer function. Since the music and voice signals contain time varying spectra, stationary frequency interference patterns can be easily recognized. Once the noise spectra with amplitude data are determined, the system controller or DSP could calculate the new Digital Filter Coefficients. These could be stored to provide adaptive filtering. This low noise calibration could be done each time the station was accessed. This information could be used to help in system set-up, where the antenna location is not optimal, such that it is receiving a low signal with various interferences (noise, multi-path, etc.).

Other Embodiments

Although the present invention has been described in detail, it should be understood that various changes, substitutions, and alterations could be made hereto without departing from the spirit and scope of the invention as defined by the appended claim. For example, the front end could be a tuner for video signals. Also, the analog tuner 22 and the A/D converter 24 may be represented by a digital tuner as a single block in the diagrams.

In another embodiment, the digital Filter 14 is incorporated in an ADC Decimation Filter. The frequency characteristics of these filters are usually chosen based on meeting Nyquist criteria. By combining the filter as part of the ADC Decimation Filter—no extra circuitry is needed. In the simplest implementation —there is $0 cost. In the more likely implementation, the only added cost is the memory space, for Digital Coefficients for each of the filters selected, and a very small area for the simple decode logic for selecting Filter 1, Filter 2, etc. The real cost is the DSP engine, which remains constant—whether the Filter is programmable or not.

1. An noise reduction circuit for an RF front end system comprising:
a. a controller circuit
b. a user interface connected to the controller circuit that provides user input to the controller which indicates the user's selection of an RF channel;
c. a RF tuner; and
d. a programmable filter that receives a signal from the RF tuner and filter program settings from the controller and then filters the signal from the RF tuner based on the filter program settings;
e. wherein the program settings for the programmable filter determined by the controller depend on the RF channel selected by the user.

2. The circuit of claim 1 further comprising a switched mode power supply that supplies power to the circuit and a source of unwanted noise.

3. The circuit of claim 1 wherein the programmable filter is a digital filter.

4. The circuit of claim 3 wherein the digital filter outputs a filtered digital signal to a digital amplifier.

5. The circuit of claim 3 wherein the digital filter outputs a filtered digital signal to an D/A converter, and an analog signal from the D/A converter is amplified by an analog class A/B amplifier.

6. The circuit of claim 3 wherein the digital filter outputs a filtered digital signal to an D/A converter, and an analog signal from the D/A converter is amplified by an analog input class D amplifier.

7. The circuit of claim 3 wherein the program setting for the programmable filter are determined by characterizing the noise of the circuit in operation for each RF band.

8. The circuit of claim 3 wherein the program setting for the programmable filter are determined by characterizing the noise of the circuit in operation for each RF band and RF channel.

9. The circuit of claim 1 wherein the programmable filter is a programmable switched capacitor filter.

10. The circuit of claim 9 wherein the programmable filter outputs a filtered analog signal to an analog input class D amplifier.

11. The circuit of claim 9 wherein the programmable filter outputs a filtered analog signal to an analog amplifier.

12. The circuit of claim 9 wherein the program setting for the programmable filter are determined by characterizing the noise of the circuit in operation for each RF band.

13. The circuit of claim 9 wherein the program setting for the programmable filter are determined by characterizing the noise of the circuit in operation for each RF band.

14. The circuit of claim 9 wherein the program setting for the programmable filter are determined by characterizing the noise of the circuit in operation for each RF band and RF channel.

15. An noise reduction circuit for an RF front end system comprising:
a. a controller circuit
b. a user interface connected to the controller circuit that provides user input to the controller which indicates the user's selection of an RF channel;
c. a RF tuner; and
d. a programmable filter incorporated in a DSP that receives a signal from the RF tuner and filter program settings from the controller and then filters the signal from the RF tuner based on the filter program settings;
e. wherein the program settings for the programmable filter determined by the controller depend on the RF channel selected by the user.

16. The circuit of claim 15 further comprising a switched mode power supply that supplies power to the circuit and a source of unwanted noise.

17. The circuit of claim 15 wherein the digital filter outputs a filtered digital signal to an D/A converter, and an analog signal from the D/A converter is amplified by an analog class A/B amplifier.

18. The circuit of claim 15 wherein the digital filter outputs a filtered digital signal to an D/A converter, and an analog signal from the DIA converter is amplified by an analog input class D amplifier.

19. The circuit of claim 15 wherein the program setting for the programmable filter are determined by characterizing the noise of the circuit in operation for each RF band.

20. The circuit of claim 15 wherein the program setting for the programmable filter are determined by characterizing the noise of the circuit in operation for each RF band and RF channel.
